(19) United States
(12) Patent Application Publication
(10) Pub. No.: US 2026/0126140 A1
(43) Pub. Date: May 7, 2026

(54) CONNECTOR FOR AN OUTDOOR STRUCTURE

(71) Applicant: Chris Cloutier, Castle Rock, CO (US)

(72) Inventor: Chris Cloutier, Castle Rock, CO (US)

(21) Appl. No.: 19/376,453

(22) Filed: Oct. 31, 2025

Related U.S. Application Data
(60) Provisional application No. 63/717,006, filed on Nov. 6, 2024.

(51) Int. Cl. F16L 33/207

(52) U.S. Cl. CPC F16L 33/2071

(57) ABSTRACT

A connector for installment in an outdoor structure to link an air-flow source with an inside of the outdoor structure. The connector includes a main body for extending through a wall of an outdoor structure and a nut for engagement with the main body to secure the connector to the outdoor structure. The connector also includes a cover assembly that includes a rotatable door portion and a hingedly connected door retaining ring.

### CROSS-REFERENCE TO RELATED APPLICATIONS

The present application is a conversion of U.S. Provisional Application having U.S. Ser. No. 63/717,006, filed Nov. 6, 2024, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to a weather-resistant and dust-sealed connector for air, with an optional positive-pressure mode for minimizing dust ingress, and an internal rotatable vent for directing airflow. The connector can be used with outdoor and mobile heating, cooling or venting systems. More specifically, the connector is used in a heater port to securely connect an external heating hose to the wall of an outdoor structure (e.g., campers, tents, truck toppers).

### 2. Description of the Related Art

Conventional ports for ventilation and heating often allow weather, dust, and pests to enter when not in use, as they lack an effective sealing mechanism. Additionally, existing solutions do not offer a positive-pressure feature to keep dust out while driving in high-dust environments. Previous solutions primarily focus on providing a simple entry point for hoses but fail to adequately address sealing, environmental protection, and dust control.

Accordingly, there is a need for a connector for heat ports that overcomes the deficiencies of the existing solutions.

### SUMMARY OF THE DISCLOSURE

The present disclosure is directed to a connector for installment in an outdoor structure to link an air-flow source with an inside of the outdoor structure. The connector includes a main body for extending through a wall of an outdoor structure and a nut for engagement with the main body to secure the connector to the outdoor structure. The connector also includes a cover assembly that includes a rotatable door portion and a hingedly connected door retaining ring.

### BRIEF DESCRIPTION OF THE DRAWINGS

FIG. 1 is a perspective view of a connector for an outdoor structure constructed in accordance with the present disclosure.

FIG. 2 is an exploded perspective view of one embodiment of the connector constructed in accordance with the present disclosure.

FIG. 3 is an exploded perspective view of another embodiment of the connector constructed in accordance with the present disclosure.

FIGS. 4A and 4B are perspective views of the connector shown in FIG. 2 and constructed in accordance with the present disclosure.

FIGS. 5A and 5B are perspective views of connector shown in FIG. 3 and constructed in accordance with the present disclosure.

FIG. 6 is a perspective view of another embodiment of the connector constructed in accordance with the present disclosure.

FIG. 7 is a perspective view of another embodiment of the connector constructed in accordance with the present disclosure.

### DETAILED DESCRIPTION OF THE DISCLOSURE

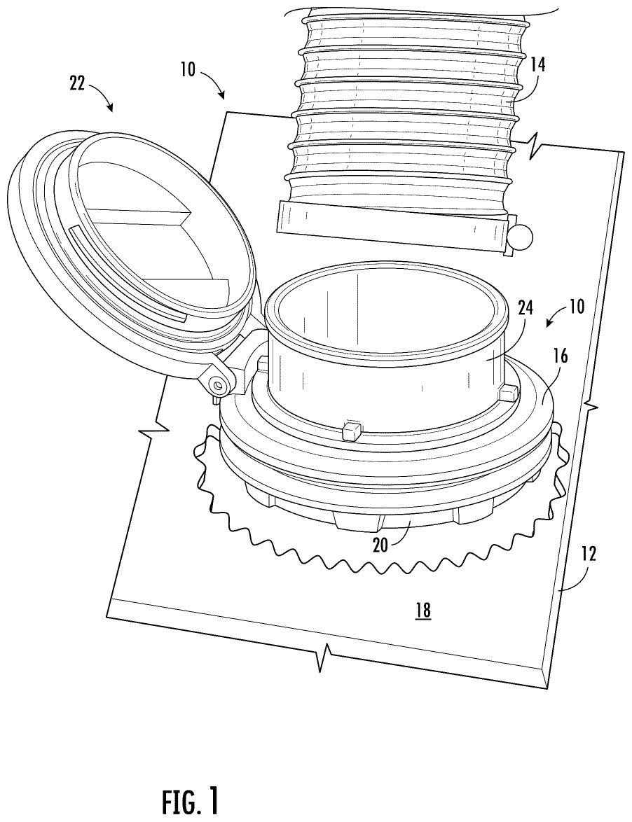

Referring now to FIG. 1, the present disclosure relates to a connector 10 for attachment to an outdoor structure 12 (e.g., tents, campers, truck toppers, vans, trailer, shed, permanent structure, tiny home, boat, etc.) to connect an air-flow source (not shown), which can provide heated, cooled, or vented air, to an interior of the outdoor structure 12. The connector 10 can be closed during transport or when air from the flow source is undesired. When the connector 10 is closed it prevents dust, debris, etc. from entering the outdoor structure 12. When it is desirable for air from the flow source to be directed into the outdoor structure 12, the connector 10 can be opened and connected to the air-flow source via any means known in the art, such as a hose 14. It should be understood and appreciated that outdoor structure is not limited in any way to a specific type of structure. It could be any structure the connector 10 could be attached to.

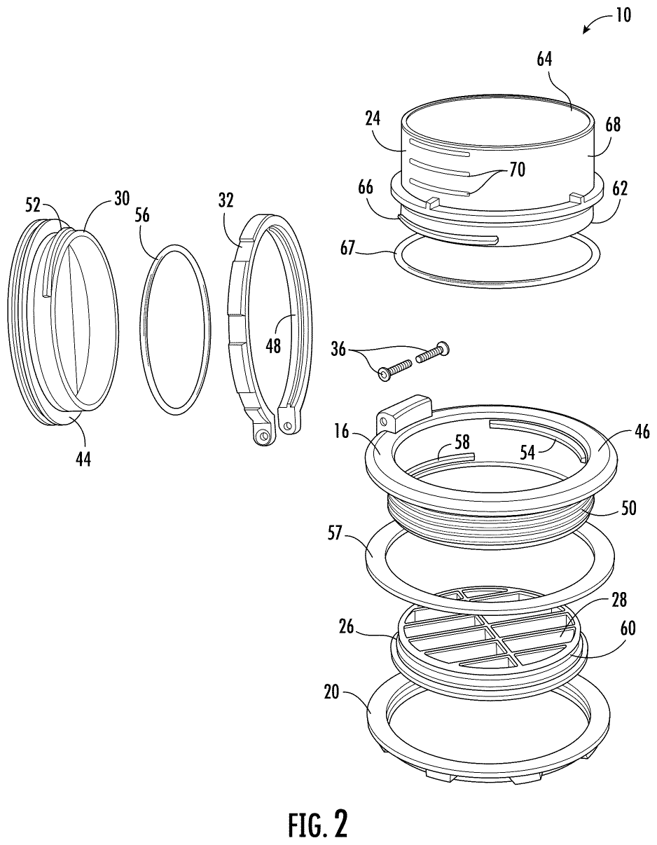

In one exemplary embodiment shown in FIG. 2, the connector 10 can include a main body 16 that passes through a wall 18 of the outdoor structure 12 and a nut 20 to be secured to the main body 16 to maintain the connector's engagement with the outdoor structure 12. The connector 10 can also include a cover assembly 22 hingedly supported by the main body 16 of the connector 10. The cover assembly 22 can be selectively engaged with the main body 16 to open or close the connector 10. The connector 10 can also include a hose adapter 24 selectively securable to the main body 16 when the cover assembly 22 is in the open position and removable from the main body 16 when it is desired to have the connector 10 closed. In another embodiment, the connector 10 can include a vent 26 disposable within the main body 16 to direct the flow of air from the air-flow source in the desired direction as the air flows into the outdoor structure 12.

The cover assembly 22 can include a door portion 30 and a door retaining ring 32 that surrounds the door portion 30 and can be hingedly coupled to a flanged portion 34 extending from the main body 16. The door portion 30 can be rotatably disposed within the door retaining ring 32. The door retaining ring 32 can be coupled to the flanged portion 34 in any manner known in the art. For example, the door retaining ring 32 can be rotatably secured to the flanged portion 34 via screws 36 that extend through openings 38 in ends of the door retaining ring 32 and engage holes 40 in the flanged portion 34. The door portion 30 can include a groove 42 disposed therein around an outer circumference of a wider part 44 of the door portion 30 that engages a lip portion 46 of the main body 16. The groove 42 engages a ridge 48 disposed on the inside of the door retaining ring 32 to permit the door portion 30 to rotate therein. The door portion 30 can also includes a narrow part extending from the wider part 44 that has at least one thread 52 disposed thereon to engage a thread or ridge 54 disposed on the inner side of the main body 16. The design of the door portion 30 and the door retaining ring 32 allows the door portion 30 to rotate and secure the cover assembly 22 in a closed position. The cover assembly 22 can also include a sealing member 56 for providing a weather-tight seal between the door portion 30 and the main body 16 of the connector 10.

In addition to the nut 20 and the main body 16, the connector 10 can include a seal 57 that can be disposed between the main body 16 and the wall 18 of the outdoor structure 12 to prevent ingress of weather, dust, debris, pests, etc. In addition to the thread or ridge 54 on the inside of the main body 16 of the connector 10, the inside of the main body 16 can include a second ridge member 58 that a groove 60 disposed on an outer side of the vent 26 to allow its rotatable relationship with the main body 16. The vent 26 can also be designed such that it is can frictionally engaged with the inside of the main body 16. Therefore, it can be disengaged from the main body 16 and reengaged at any position such that air is blowing from the vent 26 at a desired angle.

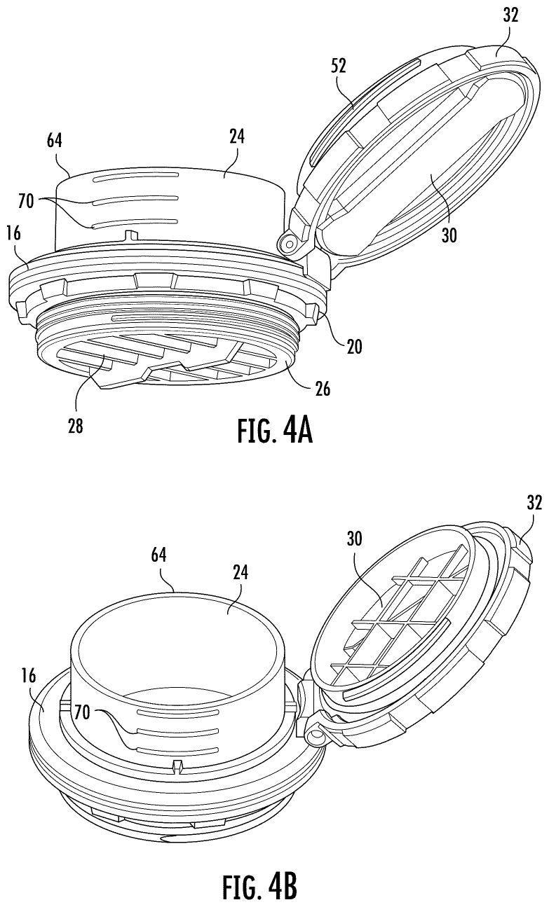

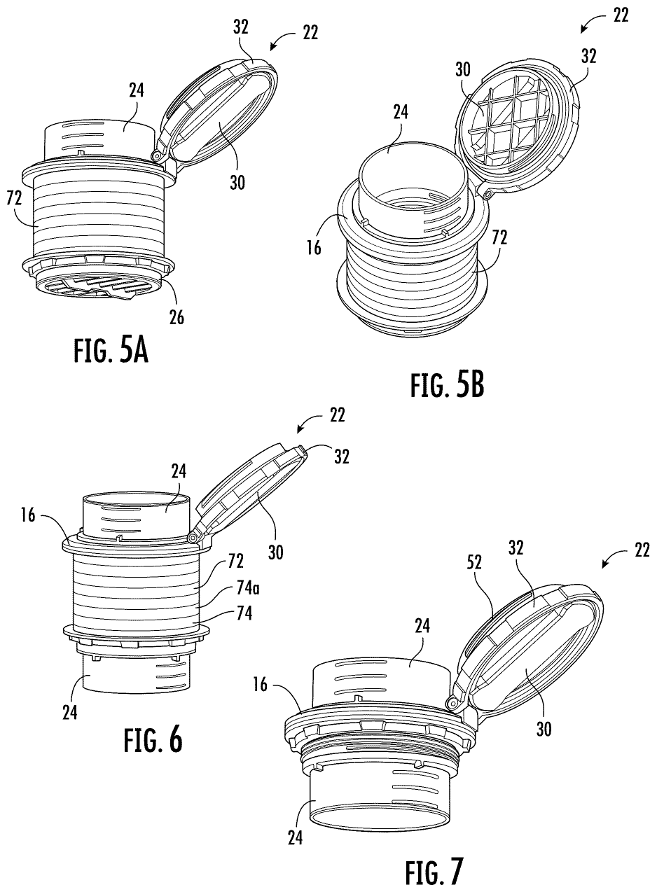

The hose adapter 24 can be designed such that it can be secured to the main body 16 of the connector 10 and allow for a hose 14 to be attached thereto on either side of the connector 10. The embodiments shown in FIGS. 1-7 show a hose adapter 24 inserted into an outer side (typically the side of the connector 10 that is on the outside of the outdoor structure 12). An insertion side 62 of the hose adapter 24 is selectively securable inside the main body 16 of the connector 10 and a hose side 64 of the hose adapter 24 extends from the main body 16 of the connector 10 to receive the hose 14 and allow the hose 14 to be secured thereto. The insertion side 62 can have a thread 66 disposed on an outer side thereof for engagement with thread or ridge 54 disposed and rotated on the inside of the main body 16. The hose side 64 can be a sleeve 68 that can have ridges 70 disposed thereon to permit a more secure attachment of the hose 14 to the hose adapter 24. In another embodiment shown in FIG. 7, the hose adapter 24 can be connected to the main body 16 of the connector 10 on an inner side of the connector 10 (i.e., the side of the connector 10 on the inside of the outdoor structure 12). In this embodiment, the thread 66 on the insertion side 62 of the hose adapter 24 is inserted into the inner side of the main body 16 wherein the thread 66 of the insertion side 62 of the hose adapter 24 engages the second ridge member 58 so that the hose adapter 24 can be rotatably secured in the main body 16 of the connector 10. The hose adapter 24 can include a sealing member 67 positioned between the hose adapter 24 and the main body 16 to help prevent dust, debris, weather, pests, etc. from entering the outdoor structure 12.

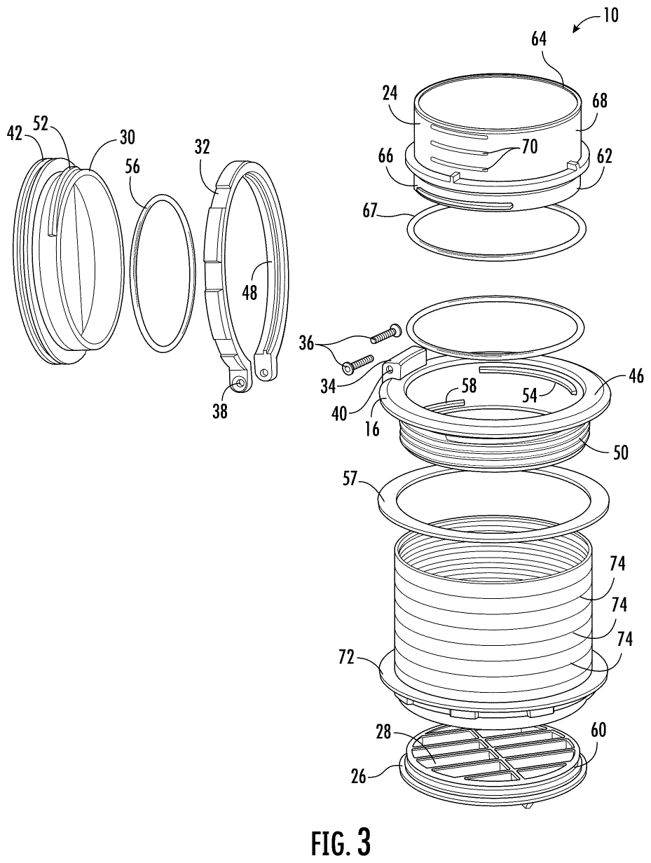

In another embodiment shown in FIGS. 3 and 5A-6, the connector 10 can include an extension sleeve 72 if the narrow part 50 of the main body 16 isn't long enough to extend through the wall of an outdoor structure 12. If the wall 18 of the outdoor structure 12 is too wide for the length of the narrow part 50 of the main body 16, the extension sleeve 72 that can be secured to the narrow part 50 of the main body 16 on one end and the vent 26 or hose adapter 24 can be supported on the other end of the extension sleeve 72. The extension sleeve 72 can be threaded on the narrow part 50 of the main body 16 and the inside of the other end of the extension sleeve 72 can include a thread or ridge to engage the vent 26 or the hose adapter 24. The extension sleeve 72 can include break sections 74 such that portions of the extension sleeve 72 can be removed to reduce the length of the extension sleeve 72 to fit the wall thickness of the outdoor structure 12. Each break section 74 can include threads so that engagement with the main body 16 can occur regardless of how many break sections 74 have been removed. An outer break section 74a can include a thread or ridge so that engagement with the vent 26 or the hose adapter 24 can still be done for any length of the extension sleeve 72.

The design of the connector 10 has a semi-locked position, referred to as the positive-pressure mode, which allows controlled airflow into the outdoor structure 12 without fully opening the connector 10. This creates positive pressure within the outdoor structure 12, which can help keep dust out, particularly useful during operation of a vehicle associated with the outdoor structure 12 in dusty conditions.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A connector for installment in an outdoor structure to link an air-flow source with an inside of the outdoor structure, the connector comprising:
a main body for extending through a wall of an outdoor structure;
a nut for engagement with the main body to secure the connector to the outdoor structure; and
a cover assembly that includes a rotatable door portion and a hingedly connected door retaining ring.

2. The connector of claim 1 wherein the door portion is rotatable within the door retaining ring.

3. The connector of claim 2 wherein the door portion includes a wider part with a groove disposed around a circumference thereof.

4. The connector of claim 3 wherein the door retaining ring includes a ridge extending circumferentially around an inner side for engaging with the groove of the door portion to support the rotatable relation between the door portion and the door retaining ring.

5. The connector of claim 4 wherein the door portion has a narrow part extending from the wider part of the door portion having a thread thereon to engage a first thread disposed on an inner side of the main body.

6. The connector of claim 1 further comprising a vent selectively securable to the main body.

7. The connector of claim 6 wherein the vent can engage with a second thread disposed on an inner side of the main body to maintain position of the vent with respect to the main body.

8. The connector of claim 6 further comprising a hose adapter selectively securable to the main body on a first end and selectively engageable by a hose on a second end.

9. The connector of claim 8 wherein the first end of the hose adapter includes a thread for engaging a first thread disposed on an inner side of the main body when the door portion of the cover assembly is in an open position.

10. The connector of claim 9 wherein the hose adapter has a sleeve on the second end that includes ridges disposed thereon to allow for better engagement with the hose.

11. The connector of claim 10 wherein the hose adapter and the main body are designed such that the first end of the hose adapter can be secured to a first thread on an inner side of the main body or a second thread on the inner side of the main body.

12. The connector of claim 1 further comprising a sealing member disposed between the nut and the main body.

13. The connector of claim 1 wherein the main body includes a flanged portion the door retaining ring is hingedly connected to.

14. The connector of claim 1 wherein the cover assembly further comprises a sealing member supported by the door portion to provide a seal between the door portion and the main body.

15. The connector of claim 1 further comprising an extension sleeve disposed between the nut and the main body to permit the connector to be used with an outdoor structure with a thicker wall.

16. The connector of claim 15 wherein the extension sleeve includes threads on an inner side that can engage threads on an outer side of the main body.

17. The connector of claim 15 wherein the extension sleeve includes break sections where the extension sleeve can have sections removed to provide the extension sleeve with a desired length.

18. The connector of claim 4 wherein the door retaining ring extends around only a portion of the door portion of the cover assembly.

19. The connector of claim 8 further comprising a second hose adapter supported by the main body.
